(19) United States
(12) Patent Application Publication
(10) Pub. No.: US 2011/0134442 A1
(43) Pub. Date: Jun. 9, 2011

(54) IMAGE FORMING APPARATUS, CONTROL METHOD FOR IMAGE FORMING APPARATUS, AND STORAGE MEDIUM

(75) Inventor: Hiroshi Mori, Tokyo (JP)

(73) Assignee: CANON KABUSHIKI KAISHA, Tokyo (JP)

(21) Appl. No.: 12/959,133

(22) Filed: Dec. 2, 2010

(30) Foreign Application Priority Data
Dec. 4, 2009 (JP) 2009-276341

(51) Int. Cl. G06K 15/02

(52) U.S. Cl. 358/1.2; 358/1.14

(57) ABSTRACT

An image forming apparatus may include a calculating unit and a display control unit. The image forming apparatus may process a job according to a charged amount charged on the job and an input amount input into a charging apparatus. The calculating unit calculates a charging amount required for outputting an image corresponding to the job according to printing setting for the job. The display control unit displays image data corresponding to the job on a display unit according to the printing setting for the job. The display control unit compares the input amount with the charged amount calculated by the calculating unit, and when the input amount is insufficient, a range of image data that can be output and a range of image data that cannot be output, of image data corresponding to the job, are displayed in a manner enabling discrimination thereof on a display unit.

### BACKGROUND OF THE INVENTION

1. Field of the Invention

The present invention relates to an image forming apparatus, a control method for the image forming apparatus, and a storage medium.

2. Description of the Related Art

Typically, a convenience store has an image output apparatus that includes a function of image output enabling print processing of documents or image data to be printed, which is brought by a user, and a charging function that charges a fee corresponding to the image output. A user inputs a fee corresponding to the image output to perform print processing or copy a document.

This type of image output apparatus charges different fees according to the output state such as monochrome or color printing, a sheet size, or the like. Furthermore, an increasing number of offices or the like have introduced a system that uses a work flow of image output which includes departmental management in which use of the image output apparatus for printing, copying or the like is limited for each user in available functions or sheet number.

In this type of image output apparatus or system, a limitation on the output sheet number or output state, and monochrome or color printing, sheet size or the like is assigned to each user, and the user can output only images limited based on that limitation.

A conventional technique with this configuration has been proposed, which includes a method in which a monetary amount is input into the image output apparatus, and the image output apparatus outputs a notification of a determination of the state of whether printing is possible or not based on the charging amount in relation to the output state, and a notification of an insufficient amount when printing output is not possible.

As discussed in Japanese Patent Application Laid-Open No 2002-183832, a method is proposed that includes the above proposal and furthermore includes the switching of a display for each printing page, and a calculation of the insufficient amount taking into account the settings, based on a printing instruction to a user indicating that printing will or will not be performed.

However, with the above-described conventional technique, the user cannot directly recognize the portion that cannot be output due to a limitation such as a monetary amount, departmental management, or the like. Thus, the user also cannot recognize intuitively a method for solving the problem, and therefore it is necessary to instruct printing by trial and error of various settings.

For example, with the conventional technique displaying that the amount is insufficient, it is not possible to determine what is output as the actual output of the document due to the insufficient amount or what type of effect the insufficient amount is causing. As a result, there is insufficient information to determine an appropriate change in the settings to eliminate the printing output failure by adding money, or by varying a layout or the like.

### SUMMARY OF THE INVENTION

According to an embodiment, an image forming apparatus includes a calculating unit and a display control unit. The image forming apparatus may process a job according to a charged amount charged on the job and an input amount input into a charging apparatus. The calculating unit calculates a charging amount required for outputting an image corresponding to the job according to printing setting for the job. The display control unit displays image data corresponding to the job on a display unit according to the printing setting for the job. The display control unit compares the input amount with the charged amount calculated by the calculating unit, and when the input amount is insufficient, a range of image data that can be output and a range of image data that cannot be output, of image data corresponding to the job, are displayed in a manner enabling discrimination thereof on a display unit.

Further features and aspects will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of an image forming system according to an exemplary embodiment.

FIG. 2A and FIG. 2B are block diagrams illustrating an example of a user interface displayed on an operation/display unit.

FIG. 3 is a flowchart illustrating a data processing sequence of the image forming apparatus.

FIG. 4 is a flowchart illustrating a data processing sequence of the image forming apparatus.

FIG. 5 is a flowchart illustrating a data processing sequence of the image forming apparatus.

FIG. 6 is a diagram illustrating an example of a user interface displayed on the operation/display unit.

FIG. 7A and FIG. 7B are diagrams illustrating an example of a user interface displayed on the operation/display unit.

FIG. 8 is a flowchart illustrating a data processing sequence of the image forming apparatus.

FIG. 9 is a flowchart illustrating a data processing sequence of the image forming apparatus.

FIG. 10A and FIG. 10B are flowcharts illustrating a data processing sequence of the image forming apparatus.

FIG. 11 illustrates a layout processing example processed by the image forming apparatus.

FIG. 12 illustrates an example of a user interface displayed on the operation/display unit.

### DESCRIPTION OF THE EMBODIMENTS

Various exemplary embodiments, features, and aspects of the invention will be described in detail below with reference to the drawings.

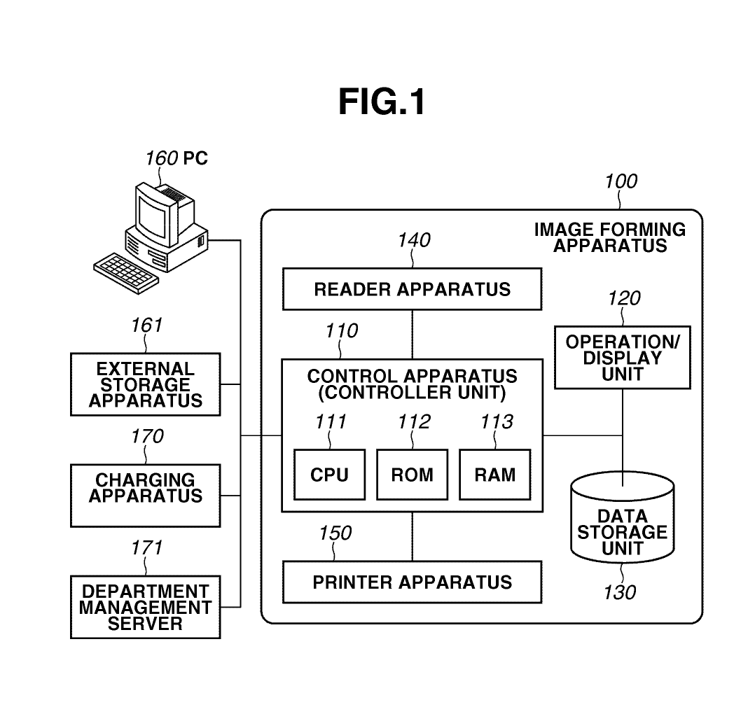

FIG. 1 is a block diagram illustrating an example of an image forming system according to an exemplary embodiment. This example illustrates a system in which a user who operates a personal computer on a network outputs a print job to an image forming apparatus 100, and then the system executes a preview control upon the payment of an amount to the charging apparatus by the user. The payment may be a transfer of wealth, such as a sum of money paid reflective of a purchase price, made in response to a demand for payment.

A system that executes preview of the output range that can be output with the input amount and other output range according to a difference in the amount calculated by comparison of the input amount for the suspended print job and the charging amount corresponding to the printing setting set for the print job will be described in detail below.

In the present exemplary embodiment, a multi function printer (MFP) will be described as an example of an image forming apparatus. However, to the present invention can be applied to a single function printer (SFP), a laser beam printer (LBP), or a printer using another printing configuration.

In FIG. 1, the image forming apparatus 100 is connected to a host computer (PC) 160 via a local area network (LAN) such as an Ethernet (registered trademark). Furthermore, the image forming apparatus 100 is configured to also be connected to an external storage apparatus 161 such as a USB memory, CD-ROM, CD-RW, DVD-ROM, DVD-RW, or the like.

The image forming apparatus 100 includes a reader apparatus 140, a printer apparatus 150, an operation/display unit 120, a data storage unit 130, and a control apparatus (control unit) 110 that controls each of these constituent elements.

The control apparatus 110 includes a central processing unit (CPU) 111, a read only memory (ROM) 112, a random access memory (RAM) 113, or the like. The CPU 111 executes integrated control of the overall image forming apparatus 100 based on programs stored in a ROM 112 or other storage medium. For example, in the present exemplary embodiment, programs are loaded in the CPU 111 for image output processing, charging management processing, display control processing of the operation/display unit 120, preview image generation processing, and the like.

The printer apparatus 150 performs output processing of the received print job or of image data input from the reader apparatus 140 (printing function/copy function).

The operation/display unit 120 includes a keyboard for operation of various types of printing setting to execute image output processing, an operation button for executing image output setting, or a liquid-crystal panel for executing advance display of the output result when executing image output.

The data storage unit 130 stores/saves print data in the form of image data, document data, printing device control language (for example, ESC code, page description language (PDL)), or the like.

For example, the data storage unit 130 stores/saves data received by the host computer (PC) 160 through the LAN such as image data, document data, PDL (print jobs), and data from a connected external storage apparatus 161 (a USB memory, an SD card or the like), in addition to image data read by controlling the reader apparatus 140.

A charging apparatus 170 allows a user to input a fee required for image output. The charging apparatus 170 may manage the input amount of coins or bills input by a user, or may manage an input amount by reading a prepaid card or credit card.

Charging information is prerecorded in the prepaid card or the credit card. The charging apparatus 170 acquires the input amount information by reading the recorded amount information. The CPU 111 executes preview processing of the output result and the charging management processing on the operation/display unit 120 according to the amount input from the charging apparatus 170.

The department management server 171 manages a limitation of the image output on a user. The CPU 111 executes preview of the output result and the charging management processing based on the image output limitation on the user that is retained in the department management server 171.

A specific exemplary embodiment will be described below using an example of an image forming apparatus having the above configuration.

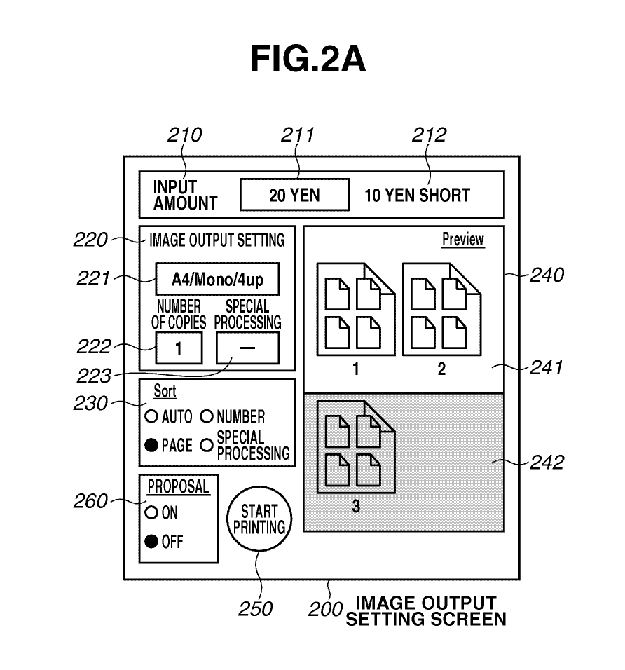

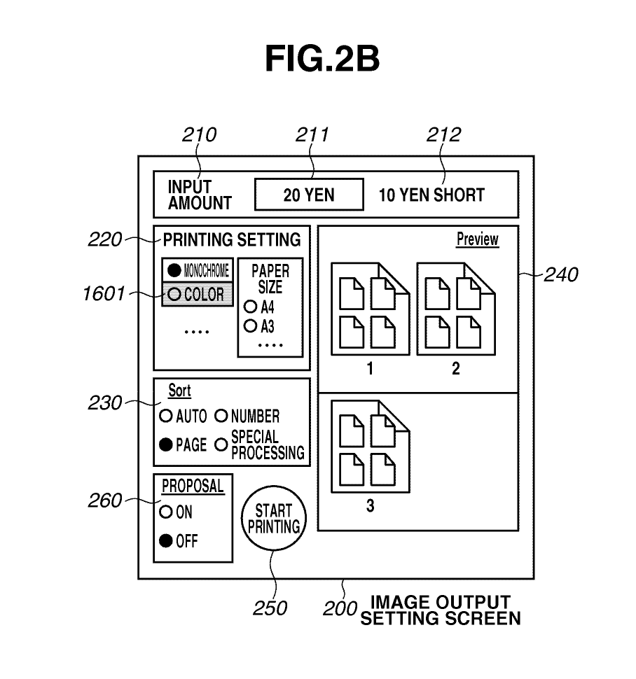

FIGS. 2A and 2B illustrate an example of a user interface displayed on the operation/display unit 120 illustrated in FIG. 1. This example corresponds to an image output setting screen 200. The present exemplary embodiment enables printing setting for a page unit, a copy number unit, an image processing unit, or a combination of a copy number unit and image processing unit.

In FIG. 2A, a fee information display field 210 displays various types of information of a fee of the image output.

The fee information display field 210 includes an input amount display field 211 and an insufficient fee display field 212. The input amount display field 211 displays an amount input from the charging apparatus 170. The insufficient fee display field 212 displays an insufficient amount calculated based on the input amount and the charged amount calculated using the image output setting including sheet size, monochrome/color setting, Nup setting, or the like.

A printing setting display field 220 display various types of information for image output setting that indicate the configuration of image data or documents to be output. The printing setting display field 220 includes an image output setting field 221, a copy number setting field 222, or a special processing setting field 223.

The printing setting display field 220 is merely an example, and may include other settings for image output.

The image output setting field 221 indicates the page setting or document layout of image data instructed for image output, and for example, executes a two-sided setting, a Nup (reduction layout) setting, a monochrome/color setting, a page size setting, or the like.

The copy number setting field 222 designates a number of copies of a document or image data for output. However this configuration is merely an example, and for example, settings for other image output including book setting, stapling, or the like may be included.

The special processing setting field 223 is used to execute setting of special processing including gloss finishing, or the like. A preview mode selection field 230 is configured to enable selection of display unit, as a preview mode, for image data or a document, such as automatic, a number of copies, pages, special processing.

A printing not-possible page preview field 240 displays the result of the preview processing of the documents or image data commanded for image output. The printing not-possible page preview field 240 includes a printing possible page preview field 241 and a printing not-possible page preview field 242. The details of preview processing will be described below.

An image output start button 250 starts output of image data or a document designated for image output according to the settings for image output. An image setting proposal selection button 260 is used to set whether or not to propose an image setting according to the input amount.

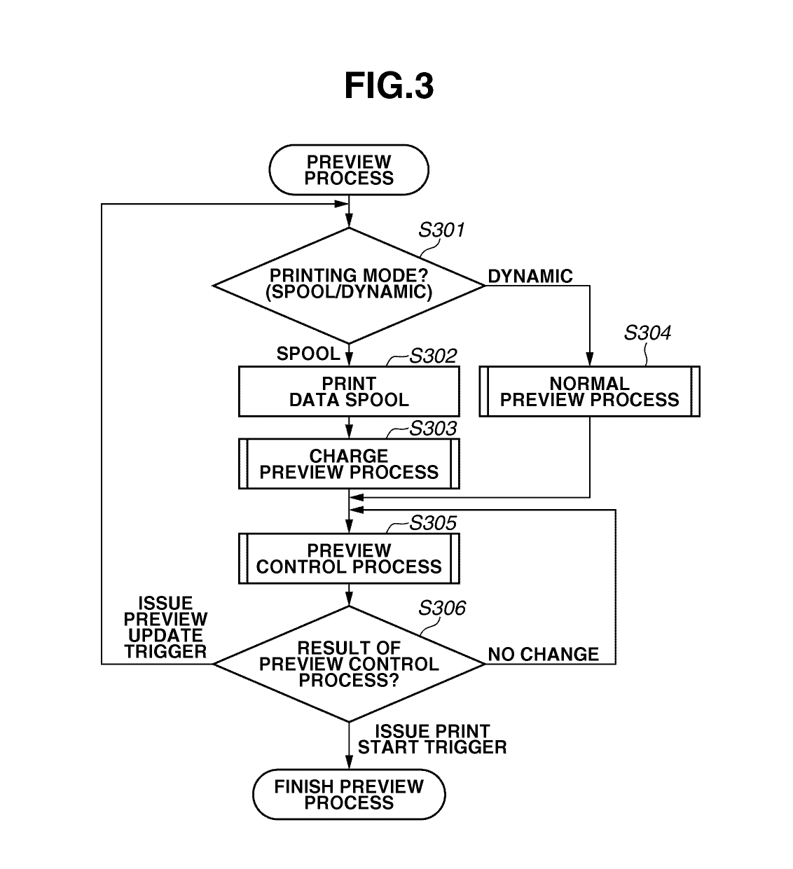

FIG. 3 is a flowchart illustrating an example of a data processing sequence of the image forming apparatus according to the present exemplary embodiment. This example illustrates preview processing by the image forming apparatus 100 for the printing not-possible page preview field 240. Each of the steps S301 to 5306 is executed by the CPU 111 by loading control programs from the ROM 112 to a RAM 113.

In step S301, the CPU 11 determines whether the current print mode is a spool mode or a dynamic mode. In a “spool mode”, image output is executed after all data is spooled to the data storage unit 130, and in a “dynamic mode” image output is executed as needed while acquiring data for image output.

In the present exemplary embodiment, the spool mode is executed when executing image output of image data from an external storage apparatus 161 or when the spool mode is designated for image data transferred from the PC 160. The dynamic mode is used when the dynamic mode is designated for image data transferred from the PC 160. Furthermore, a configuration may be adopted in which a user may execute an arbitrary designation from the operation/display unit 120.

In step S301, when the CPU 111 determines that the print mode is a spool mode, the processing proceeds to step S302, and when the CPU 111 determines that the print mode is a dynamic mode, the processing proceeds to step S304. In step S302, the CPU 111 spools the print data generated from the print job received from the PC 160 onto the data storage unit 130. The image data or document stored in the data storage unit 130 is image data or a document designated by the external storage apparatus 161 or the PC 160.

Then in step S303, the CPU 111 executes preview processing of a document or image data for image output, and executes preview processing according to a difference between the charged amount and the input amount. In other words, there is a case where the amount input by a user into the charging apparatus 170 may be short of the amount to be paid for output of the spooled image data or the document.

The charged amount calculated based on the contents designated for image output, and the input amount are determined, and charging preview processing is executed that enables an intuitively understood preview including a result for output positions for which the input amount is insufficient. In other words, the CPU 111 executes a display that enables discrimination of the range of what can be output and the range of what cannot be output on the previewed image data. The details of the charging preview processing will be described below.

In step S304, the CPU 111 executes normal preview processing and the processing proceeds to step S305. The normal preview processing corresponds to the display processing of the output result in advance when executing image output. The details thereof are omitted from the description herein.

In step S305, the CPU 111 starts the control processing of the preview processing, and in step S306, the CPU 111 determines whether updating of the preview processing is required, whether it is necessary to finish the preview processing, or whether particular processing is required.

The required conditions for updating of the preview processing includes cases where the settings for image output have been updated, the input amount has been changed, or the image data or document for image output has been changed. When any of the conditions is detected, the processing returns to step S301. In step S306, when the CPU 111 determines that there is no change to the state, the processing returns to step S305, and preview control processing is repeated.

When it is necessary to finish the preview processing, i.e., the image output start button 250 is pressed, the current preview processing is finished.

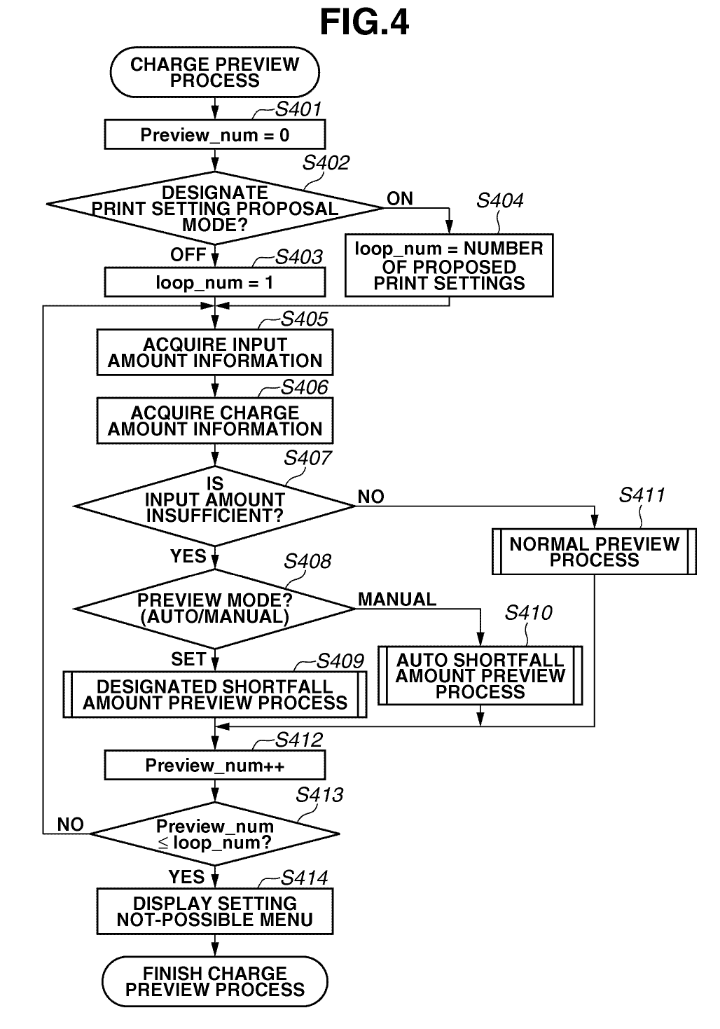

FIG. 4 is a flowchart illustrating an example of a data processing sequence of the image forming apparatus according to the present exemplary embodiment. This example illustrates the details of the charging preview processing in step S303. Steps S401 to 5414 are executed by the CPU 111 loading control programs from the ROM 112 into the RAM 113.

In the present exemplary embodiment, the modes for executing preview of the output possible range according to the printing setting set for the print job and the other output range include an auto preview mode and a designated preview mode.

For example, in the designated preview mode, a user can select the preview through a user interface described below, or designate the preview with a printer driver in a PC, by a page unit, a copy number unit, or an image processing unit.

In step S401, the CPU 111 executes initializing processing of the charging preview processing. More specifically, the CPU 111 sets a value of “0” to a parameter preview_num that is managed by the RAM 113. The parameter preview_num is information indicating the number of completed preview processes, and is initialized to a value of “0” when the charging preview processing is started up.

In step S402, the CPU 111 determines whether the printing setting proposal mode is designated. This determination determines the state of the image setting proposal selection button 260 changed according to a user operation. When the CPU 111 determines that OFF has been selected, the processing proceeds to step S403, and when the CPU 111 determines that ON has been selected, the processing proceeds to step S404.

In step S403, the parameter loop_num for counting the number of required preview processing is initialized. The parameter loop_num illustrates the number of required preview processings. When the image setting proposal selection button 260 is OFF, since the designated image data or the document is only output using the designated image output setting, the parameter is initialized to a value of “1”.

In step S404, in the same manner as step S403, the number of required preview processings is initialized. When the image setting proposal selection button 260 is ON, since it is assumed that there is a plurality of candidates for proposed image settings, there is a plurality of image data or documents to be previewed. Thus, the CPU 111 initializes the parameter loop_num to the number of proposed printing settings.

Then in step S405, the CPU 111 acquires information for the input amount from the charging apparatus 170. This process acquires the input amount managed by the charging apparatus 170. Then in step S406, the CPU 111 calculates the charging amount that shows the amount information required for image output.

The calculation method of the charging amount is executed using the same process as the conventional technique. For example, the amount information required for each setting for image output is determined in advance, and the charging amount is calculated based on the value for the amount information. The CPU 111 calculates the charging amount by referring to a calculation table corresponding to the function settings.

In step S407, the CPU 111 determines whether or not the input amount is insufficient based on the difference between the calculated charging amount and the input amount.

The CPU 111 determines whether or not the input amount acquired from the charging apparatus 170 in step S405 has a difference of “0” from the charging amount calculated in step S406, and it is determined whether or not the input amount is insufficient. Herein, when the CPU 111 determines that the input amount is insufficient (YES in step S407), the processing proceeds to step S408, and when the CPU 111 determines that it is not insufficient (NO in step S407), the processing proceeds to step S411.

In step S408, the CPU 111 determines the selection state of the mode, i.e., whether the image forming apparatus has automatically selected an optimal preview mode for the user, or whether the user has made an arbitrary setting. Actually, when the CPU 111 determines that “auto” has been selected in the preview mode selection field 230, the processing proceeds to step S410, and when the CPU 111 determines that other than “auto” has been selected, the processing proceeds to step S409.

In step S409, the CPU 111 executes a designated insufficient amount preview processing according to the mode selected in the preview mode selection field 230, and the processing proceeds to step S412. The details of the designated insufficient amount preview processing will be described below.

In step S410, an automatic insufficient amount preview processing is executed in which a preview is performed by selecting the mode automatically in which the preview of the insufficient amount is easily understood by a user, and then the processing proceeds to step S412. The details of the automatic insufficient amount preview processing are described below.

In step S412, the parameter preview_nu for updating the preview number information is incremented to thereby update the preview number, and then the processing proceeds to step S413. Herein, the parameter preview_nu is used to count the number of preview processings of a series of image output settings.

In step S413, the CPU 111 determines whether or not the charging preview process is completed. Actually, it is determined whether or not the completed preview number (preview_num) is greater than or equal to the preview number (loop_num) required for processing. When the CPU 111 determines that the charging preview processing is not completed (NO in step S413), the processing returns to step S405, and the processing from S405 is repeated.

In step S414, the CPU 111 executes gray-out display of a not-possible setting menu that is the result of an insufficient input amount inserted into the charging apparatus 170 by the user, and the processing is finished.

Specifically, the CPU 111a calculates the charging amount when settings other than the image output settings currently set is reflected, it is determined whether or not printing is possible, and then the menu on the image output setting screen for display on the operation/display unit 120 is updated.

For example, when it is assumed that the current setting is a monochrome setting, the CPU 111 calculates the charging amount when the image output setting is changed to a color setting. When the CPU 111 determines that the input amount input into the charging apparatus 170 by a user is insufficient, the menu display of the monochrome/color setting 1601 in the printing setting display field 220 is switched to a gray-out display.

Although the description has been given to only a monochrome/color setting, a configuration may be provided including the same processing to other menus.

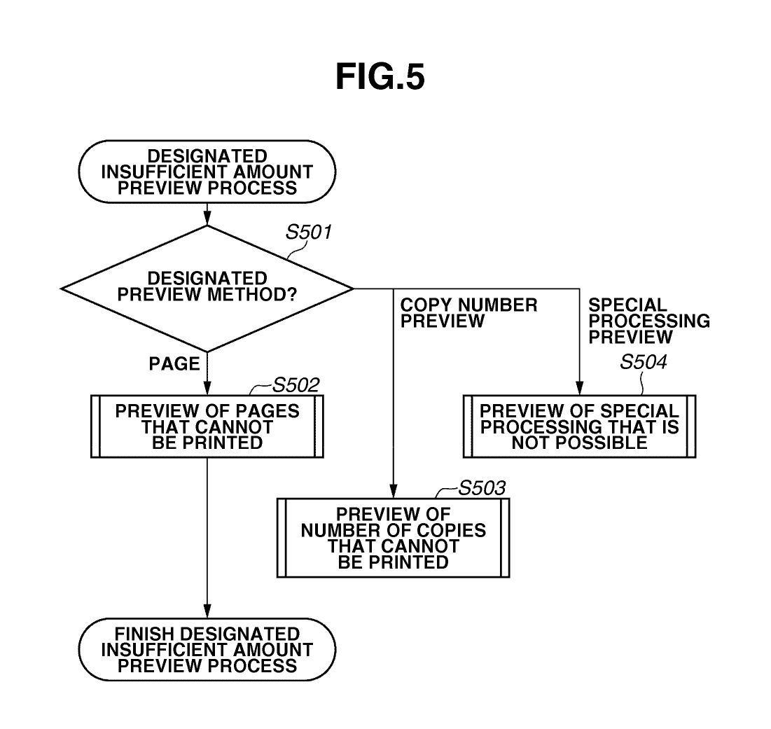

FIG. 5 is a flowchart illustrating a data processing sequence of the image forming apparatus according to the present exemplary embodiment. This example illustrates the details of the designated insufficient amount preview processing in step S409. Each of the steps is executed by the CPU 111 loading control programs from the ROM 112 into the RAM 113.

In step S501, the CPU 111 acquires information related to the preview method to be designated, and determines whether or not it corresponds to any of the predetermined preview methods to be executed. Actually, when the CPU 111 determines that a “page” is designated by the preview mode selection field 230, the processing proceeds to step S502.

When the CPU 111 determines that the “number of copies” is designated in the preview mode selection field 230, the processing proceeds to step S503. Furthermore, when the CPU 111 determines that “special processing” is designated by the preview mode selection field 230, the processing proceeds to step S504. Then, in step S502, the CPU 111 executes a printing not-possible page preview processing in which the preview image is disposed by page units on the print not-possible page preview field 240. Then, the processing is terminated.

The actual display is performed to display the printing not-possible page preview field 242 as illustrated in FIG. 2A.

In FIG. 2A, the printing possible page preview field 241 previews those print possible pages, and displays by a normal preview process pages of which image output is possible based on the charging amount and the input amount. In the present exemplary embodiment, the printing not-possible page preview field 242 corresponds to a region to be displayed in gray-out format in contrast to the printing possible page preview field 241. In an example, a gray-out format may include a neutral achromatic color between white and black.

The printing possible page preview field 241 corresponds to the range that can be output according to the set printing settings, and the printing not-possible page preview field 242 corresponds to other output range. In particular, the printing not-possible page preview field 242 corresponds to the region which is displayed as a range in which print processing cannot be executed since the user has not input an amount corresponding to the charging amount.

The details of this preview processing including the specification of pages that can be output will be described below.

The printing not-possible page preview field 242 is used to execute a preview of the pages that cannot be printed, and displays the pages that cannot be output due to the difference between the charging amount and the input amount by a unique preview processing. The details of this preview processing including the specification of pages that cannot be output as an image will be described below.

As the unique preview processing, gray-out display is employed in the present exemplary embodiment, however, another method may be employed.

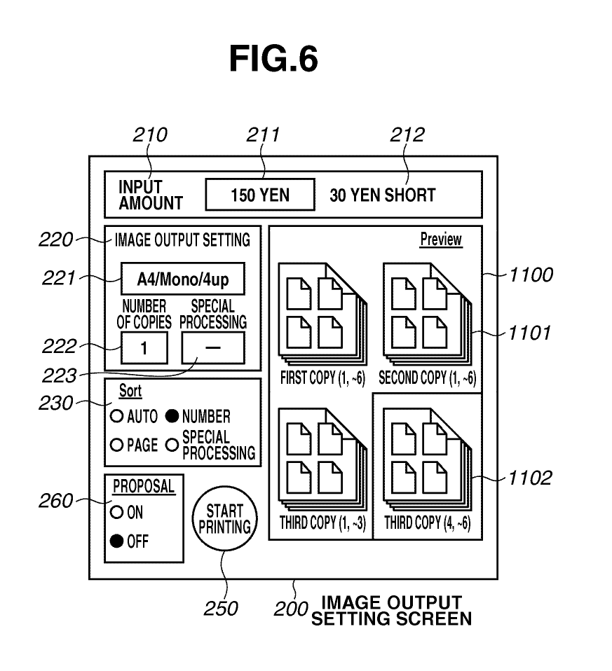

In step S503, the CPU 111 executes the printing not-possible copy number preview processing by displaying the preview image that is displayed on the print not-possible page preview field 240 by a copy number unit. The actual display as illustrated in FIG. 6 displays the printing not-possible copy number preview field 1100.

In FIG. 6, the printing not-possible copy number preview field 1100 includes the printing possible copy number preview field 1101 and the printing not-possible copy number preview field 1102. The printing possible copy number preview field 1101 is used to execute preview of the number of copies that can be printed. The number of copies that can be output as an image based on the charging amount and the input amount is displayed by a normal preview process. The details of the preview processing including the specification of the number of copies that can be output as an image will be described below.

The printing not-possible copy number preview field 1102 is used to execute preview of the number of copies that cannot be printed, and displays the number of copies that cannot be output as an image based on the charging amount and the input amount. The details of the preview processing including the specification of the number of copies that cannot be output as an image will be described below.

As the unique preview processing, the gray-out display is employed in the present exemplary embodiment, however, another method may be employed.

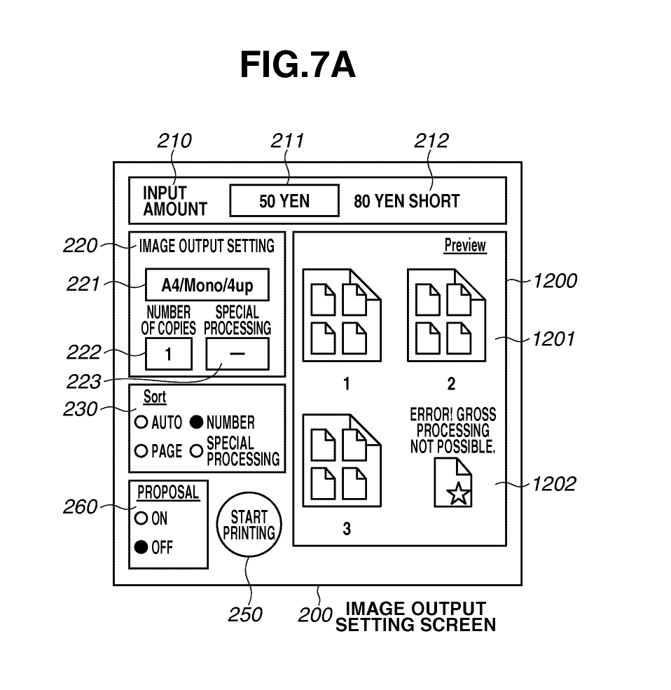

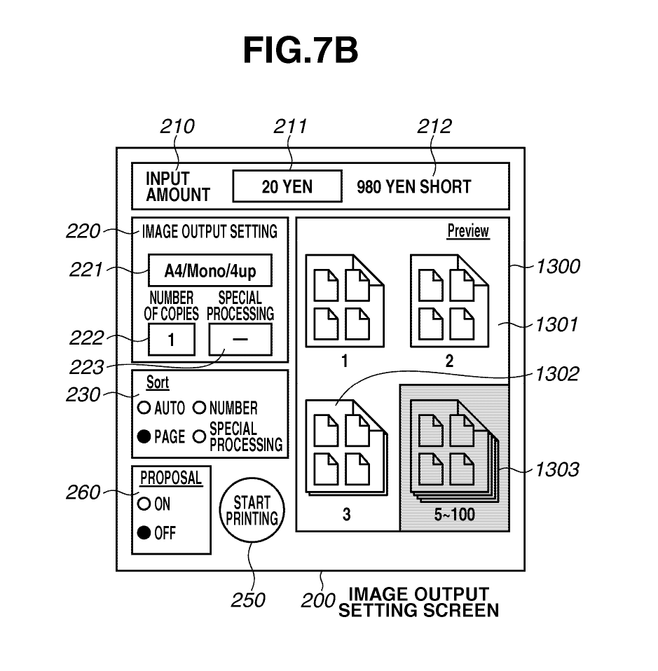

In step S504, the CPU 111 executes the special processing not-possible preview processing by displaying the preview image, which is displayed in the preview display field, by special processing units. The actual display is performed by displaying the special processing not-possible preview field 1200 as illustrated in FIG. 7A.

In FIG. 7A, the special processing not-possible preview field 1200 displays a normal preview field 1201 and a special processing not-possible mark field 1202. The normal preview field 1201 is used to execute the normal preview processing. Regardless whether printing is possible or not possible, the preview of all image output pages is performed by page units only in one part.

In the special processing not-possible mark field 1202, when it is determined that the image output is possible based on the calculation of whether or not special processing is not possible according to the difference of the input amount and the charging amount, no display is executed. When image output is not possible, a warning display is executed to notify that special processing image output is not possible.

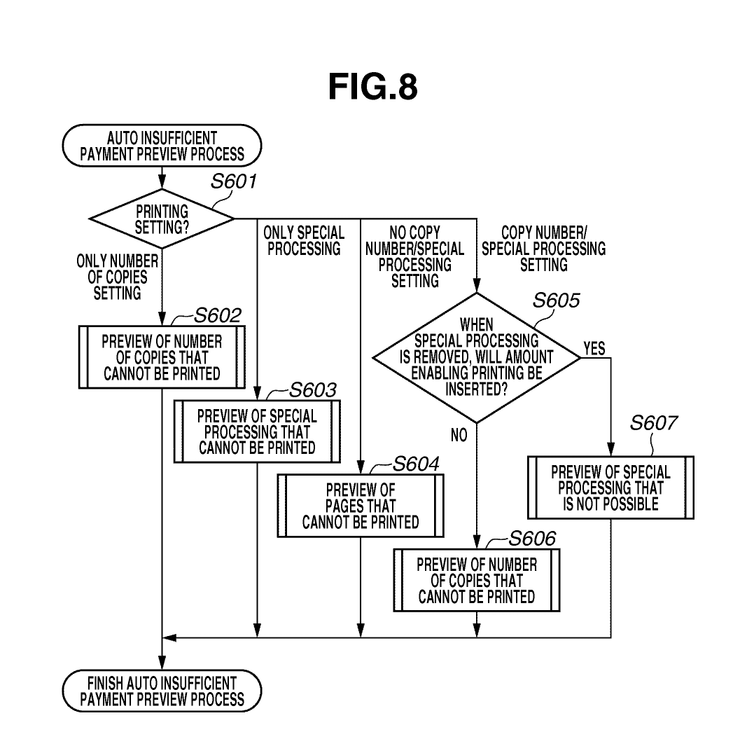

FIG. 8 is a flowchart illustrating a data processing sequence of the image forming apparatus according to the present exemplary embodiment. This example illustrates the details of the automatic insufficient amount preview processing performed in step S410. Each of the steps S601 to 5607 is executed by the CPU 111 loading control programs from the ROM 112 into the RAM 113.

In step S601, the CPU 111 executes a determination processing to automatically select the optimal preview mode for a user according to each setting value set by the user for image output. When the CPU 111 determines that the image output setting is “only designating number of copies”, the processing proceeds to step S602.

When the CPU 111 determines that the image output setting is “special processing only”, the processing proceeds to step S603. When the CPU 111 determines that the image output setting is “no copy number/special processing is set”, the processing proceeds to step S604. Furthermore, when the CPU 111 determines that the image output setting is “copy number/special processing is set”, the processing proceeds to step S605.

In step S602, the CPU 111 executes the print not-possible copy number preview processing, and then finishes the processing. The processing in step S602 is the same as the processing illustrated in step S503.

In step S603, the CPU 111 executes special processing not-possible preview processing, and then finishes the processing. The processing in step S603 is the same as the processing in step S504.

Furthermore, in step S604, the CPU 111 executes printing not-possible page preview processing, and then finishes the processing. The processing in step S604 is the same as the processing in step S502.

In step S605, the CPU 111 determines whether or not the input amount satisfies the charging amount for execution of the image output of the image data with the image output settings except for special processing. When the CPU 111 determines that the charging amount is satisfied (YES in step S605), the processing proceeds to step S607, and when the CPU 111 determines that the charging amount is not satisfied (NO in step S605), the processing proceeds to step S606.

In step S606, the CPU 111 executes printing not-possible copy number preview processing, and then finishes the processing. The processing in step S606 is the same as the processing in step S503.

In step S607, the CPU 111 executes special processing not-possible preview processing, and then finishes the processing. The processing in step S607 is the same as the processing in step S504.

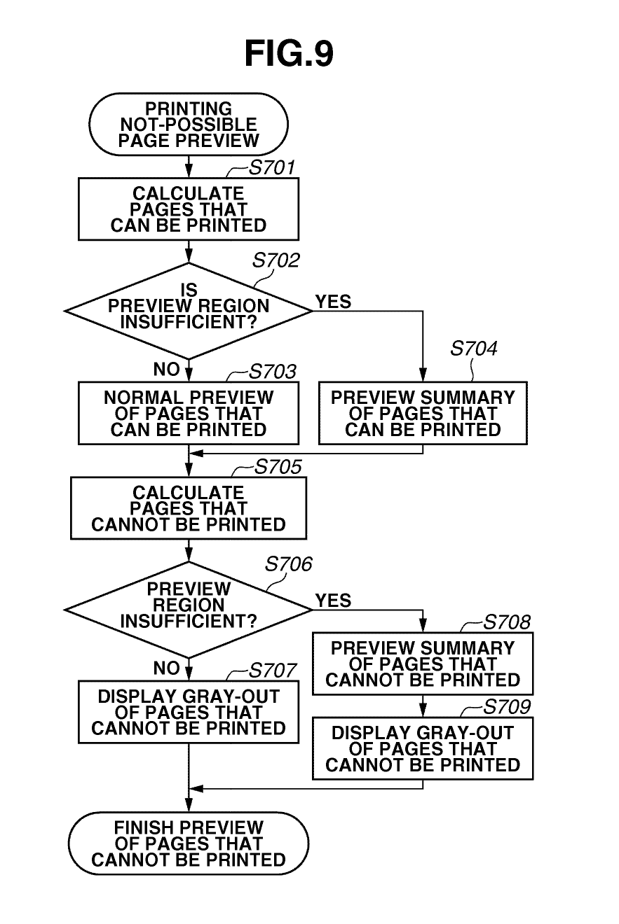

FIG. 9 is a flowchart illustrating a data processing sequence of the image forming apparatus according to the present exemplary embodiment. This example illustrates the details of the printing not-possible page preview processing illustrated in FIG. 5 and FIG. 8. Each of the steps is executed by the CPU 111 loading control programs from the ROM 112 into the RAM 113.

In step S701, the CPU 111 calculates the page number that can be printed. For example, the calculation may be executed as illustrated below.

Number of pages that can be printed=((input amount÷(monochrome/color unit price)))×N−up

Next in step S702, the CPU 111 determines whether or not the preview region for the pages that can be printed is insufficient. By a method of calculation, the number of preview image regions is four that can be displayed by the printing not-possible page preview field 240 in FIG. 6. Two pages can be printed. Furthermore, although a minimum of one page must be remained for the preview of the printing not-possible page, even in that case, since there are three regions that can be used, it is determined that the preview region is not insufficient (NO in step S702), then the processing proceeds to step S703.

There are four preview images that are displayed in the preview display field as illustrated in FIG. 7B. There are four pages that can be printed. Furthermore, although a minimum of one page must be remained for the preview of the pages that cannot be printed, since there are five regions to be used, it is determined that the preview region is insufficient (YES in step S702), the processing proceeds to step S704.

In step S703, the CPU 111 executes normal preview processing of the pages for the number of pages that can be printed calculated in step S701, and the preview image is displayed in the preview field 241 for pages that can be printed as illustrated in FIG. 6.

In step S704, the CPU 111 executes a summary display of the pages that can be printed, and the processing proceeds to step S705. More specifically, for example, as illustrated in FIG. 7B, since there are five regions to be used, for the pages that can be printed, the number of fields to be used must be suppressed within three regions. Therefore the CPU 111 executes normal preview of a first page and a second page, and executes a summary display of the third page and fourth page as illustrated by the summary preview 1302 for pages that can be printed.

Next in step S705, the CPU 111 calculates the number of pages that cannot be printed using the calculation formula below.

Number of pages that cannot be printed=total page number−number of pages that can be printed

Then, in step S706, the CPU 111 determines whether or not the preview region for the pages that cannot be printed is insufficient.

As a method of calculation, the four preview images can be displayed by the printing not-possible page preview field 240 in FIG. 6A, for example. Since there are two images that are used for pages that can be printed, then there are two regions that can be used for the preview of the pages that cannot be printed. However, since one region is used for the pages that cannot be printed, it is determined that the preview region is not insufficient (NO in step S706), and the processing proceeds to step S707.

There are four preview images that can be displayed in the preview display field as illustrated in FIG. 7B. Since there are three images that can be used for pages that can be printed, there is one region that is used for the pages that cannot be printed. There are 96 regions that can be used for pages that cannot be printed, and it is determined that the preview region is insufficient (YES in step S706), then the processing proceeds to step S708.

In step S707, the CPU 111 executes a gray-out display of the images that has been processed by normal preview processing for the number of pages that cannot be printed as calculated in step S705 and, executes display on the printing not-possible preview field 1002, and then, finishes the processing.

In step S708, the CPU 111 executes a summary display of the pages that cannot be printed. For example, in the example illustrated in FIG. 7B, although there are 96 regions that can be used, the pages that cannot be printed must be reduced to the use of one region. Thus, the pages from the 5th page to the 100th page is displayed as a summary in the form of a summary preview 1303 of the pages that cannot be printed.

In step S709, the CPU 111 additionally executes a gray-out display of the summary preview 1303 of the pages that cannot be printed as displayed in step S708, and finishes the processing.

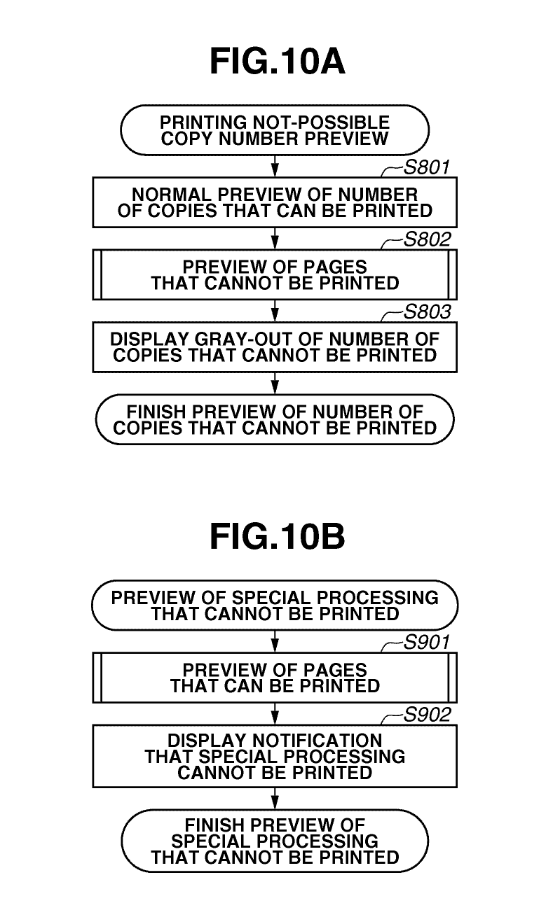

FIGS. 10A and 10B are flowcharts illustrating a data processing sequence of the image forming apparatus according to the present exemplary embodiment. FIG. 10A corresponds to an example of preview processing of the number of copies that cannot be printed. Each of the steps is executed by the CPU 111 by loading control programs from the ROM 112 into the RAM 113.

Firstly, in step S801, the CPU 111 executes extraction processing of the number of copies that can be printed according to the calculation formula below.

Number of copies that can be printed=input amount÷((monochrome/color unit price)×(total number of pages÷N−up)) Then, the CPU 111 executes normal preview processing for the number of pages that can be printed calculated as described above, and then displays the result on the preview field 1101 of the number of copies that can be printed.

In step S802, the CPU 111 executes a preview of the number of copies that can be printed up to a point midway in the pages, and therefore the CPU 111 executes printing not-possible preview processing including the residual input amount calculated based on the calculation formula below. The amount calculated below is processed as the residual input amount.

Residual input amount=input amount−(number of copies that can be printed×total page number×(monochrome/color unit price))÷N−up

The residual input amount as calculated above is used as the input amount to execute the preview processing of pages that cannot be printed. More specifically, normal preview processing for the number of pages that can be printed is executed and displayed on the preview field 1101 for the number of copies that can be printed. Normal preview processing is executed for the number of pages that cannot be printed and is displayed on the preview field 1102 for the number of copies that cannot be printed.

In step S803, the CPU 111 executes an extraction processing for the number of copies that cannot be printed calculated based on the calculation formula below.

Number of copies that cannot be printed=total number of copies−number of copies that can be printed

Herein, the CPU 111 decrements the number of copies that can be printed by one when executing preview processing in step S802.

The CPU 111 executes gray-out display of the image subjected to the normal preview processing for the number of copies that cannot be printed as calculated above, displays the result on the preview field 1102 for the number of copies that cannot be printed, and then finishes the processing.

When special processing not-possible preview processing is started, in step S901, the CPU 111 executes normal preview processing for one section. In step S902, the CPU 111 displays a notification that special processing cannot be performed, and then finishes the processing.

The performance of step S902 corresponds to the situation in which the input amount is insufficient when executing this processing. Thus, it is preferred to exclude the special processing rather than to adjust the complicated image settings to restrain the cost. Thus, in the special processing preview, the user is notified of the fact that special processing is not possible, and then the processing is finished.

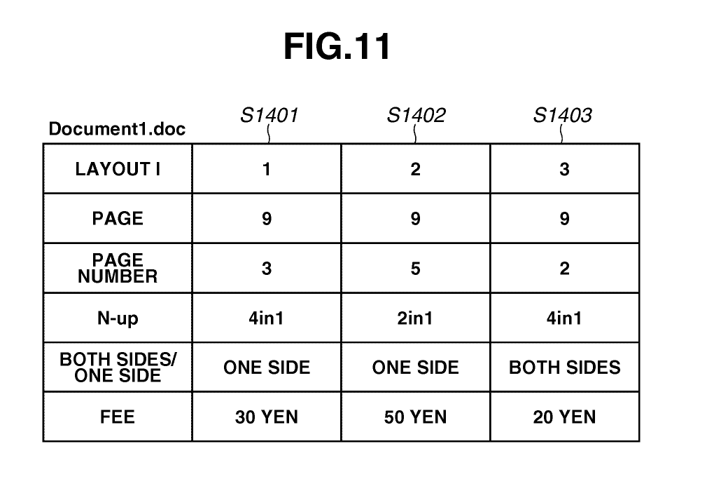

FIG. 11 is a table illustrating an example of layout processing processed by the image forming apparatus according to the present exemplary embodiment. The present exemplary embodiment illustrates three configurations of a proposal layout when image setting proposal selection button 260 in FIG. 2 is set ON. The proposal processing itself is executed using a conventional technique.

As illustrated in FIG. 11, in the present exemplary embodiment, three layouts such as the layout ID1, the layout ID2, and the layout ID3 are proposed.

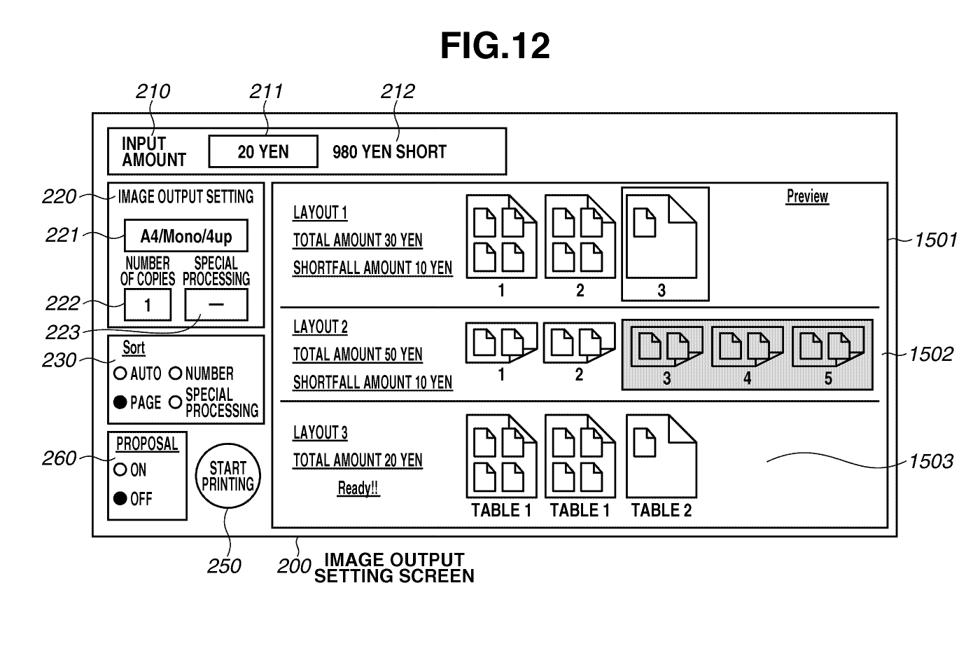

FIG. 12 illustrates an example of a user interface displayed on an operation/display unit according to the present exemplary embodiment. This example illustrates the preview state when executing a proposal layout processing as illustrated in FIG. 11.

Since the user interface illustrated in FIG. 12 proposes three layouts proposed in FIG. 11, the CPU 111 determines that a printing setting proposal mode has been designated in the determination process in step S402, and sets a value of “3” as the loop_num in step S404. Then, a layout proposed preview 1501, a layout proposed preview 1502, a layout proposed preview 1503 are displayed by repeating three times the series of processing steps after step S405.

In the present exemplary embodiment, although a preview processing when printing is/is not possible can be described according to a fee input by a user, however, it is not limited to the fee. Therefore, the present invention may be applied to the image output limitation of the image output for each user of a department in a management system.

In the exemplary embodiment described above, a method has been described in which the image data transferred from the PC 160 is received, and the input amount is compared with the amount required to print the received image data, to thereby execute a preview process.

This invention is not limited to the above-described exemplary embodiments. For example, application is also possible to a copying machine. More specifically, the image forming apparatus 100 may use a reader apparatus 140 to read a plurality of documents to temporarily store the image data in the data storage unit 130, then compare the input amount with the fee required to print the stored image data, and thereby execute a preview processing.

The image forming apparatus 100 may temporarily store the image data read from an external storage apparatus 161 in the data storage unit 130, then compare the input amount with the fee required to print the stored image data, and thereby execute a preview processing. The image forming apparatus 100 may compare the input amount with the fee required to print the stored image data stored in the external storage apparatus 161 while leaving the data in the external storage apparatus 161, and thereby execute a preview process.

Aspects of the embodiments can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention. In an example, a computer-readable medium or a computer-readable storage medium may store a program that causes an image forming apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-276341 filed Dec. 4, 2009, which is hereby incorporated by reference herein in its entirety.

What is claimed is:

1. An image forming apparatus for processing a job according to a charged amount charged on the job and an input amount input into a charging apparatus, the image forming apparatus comprising:
a calculating unit configured to calculate a charging amount required for outputting an image corresponding to the job according to printing setting for the job; and
a display control unit configured to display image data corresponding to the job on a display unit according to the printing setting for the job,
wherein the display control unit compares the input amount with the charged amount calculated by the calculating unit, and when the input amount is insufficient, a range of image data that can be output and a range of image data that cannot be output, of image data corresponding to the job, are displayed in a manner enabling discrimination thereof on a display unit.

2. An image forming apparatus according to claim 1, further comprising:
a setting unit configured to set whether to execute automatic display of the range of image data that can be output or the range of image data that cannot be output with the display control unit.

3. An image forming apparatus according to claim 1, wherein the printing setting includes at least any one of a monochrome/color setting, a reduced layout setting, and a sheet size setting.

4. An image forming apparatus according to claim 1, wherein the display control unit displays the range of image data that cannot be output on the display unit in a gray-out format.

5. A control method for controlling an image forming apparatus that processes a job according to a charged amount and an input amount into a charging apparatus, the control method comprising:
calculating a charging amount required for outputting an image corresponding to the job according to printing setting for the job; and
displaying on a display unit image data corresponding to the job according to the printing setting for the job,
wherein the input amount is compared with the calculated charged amount, and when the input amount is insufficient, the range of the image data that can be output and the range of the image data that cannot be output, of the image data corresponding to the job, are displayed in a manner enabling discrimination thereof on a display unit.

6. A computer-readable medium having stored thereon, a program that causes an image forming apparatus to perform a method according to claim 5.

7. A non-transitory computer-readable storage medium storing a computer program for controlling an image forming apparatus for processing a job according to an input amount input into a charging apparatus, the non-transitory computer-readable storage medium comprising:
a code to calculate a charging amount required for outputting an image corresponding to the job according to printing setting for the job; and
a code to display image data corresponding to the job according to the printing setting for the job on a display unit,
wherein the input amount is compared with the calculated charged amount, and when the input amount is insufficient, a range of the image data that can be output and a range of the image data that cannot be output, of the image data corresponding to the job, are displayed in a manner enabling discrimination on a display unit.
